(19) United States
(12) Patent Application Publication
(10) Pub. No.: US 2022/0239502 A1
(43) Pub. Date: Jul. 28, 2022

(54) System to Securely Issue and Count Electronic Ballots

(71) Applicant: Anderson Software LLC, Tempe, AZ (US)

(72) Inventor: Brandon D. Anderson, Tempe, AZ (US)

(73) Assignee: Anderson Software LLC, Tempe, AZ (US)

(21) Appl. No.: 17/649,059

(22) Filed: Jan. 26, 2022

Related U.S. Application Data
(60) Provisional application No. 63/142,055, filed on Jan. 27, 2021.

(51) Int. Cl. H04L 9/32; H04L 9/30

(52) U.S. Cl. CPC H04L 9/3257; H04L 2209/463; H04L 9/3239; H04L 9/3073

(57) ABSTRACT

A voting system has a voter key pair including a voter private key and a voter public key. The voter public key is blinded. A plurality of candidate key pairs is generated. Each candidate key pair includes a candidate private key and a candidate public key. The blinded voter public key is signed with each of the plurality of candidate private keys or a subset of the plurality of candidate private keys to create a plurality of blinded signatures. The plurality of blinded signatures is unblinded to generate a plurality of unblinded signatures valid for the voter public key. A vote is cast using the voter public key and the plurality of unblinded signatures.

### CLAIM OF DOMESTIC PRIORITY

The present application claims the benefit of U.S. Provisional Application No. 63/142,055, filed Jan. 27, 2021, which application is incorporated herein by reference.

### FIELD OF THE INVENTION

The present invention relates in general to an electronic voting system and, more particularly, to a system to securely issue and count electronic ballots.

### BACKGROUND OF THE INVENTION

Researchers have rushed to apply blockchain technology to every imaginable application since the blockchain concept was first introduced in the Bitcoin white paper for an electronic currency protocol. Few problems distinguish themselves as a potential application of blockchain technology as strongly as electronic voting. Large-scale voting has always been plagued with security problems as there are large incentives to win, while simultaneously requiring complete trust in those delegated to record the votes in difficult-to-audit systems. The immutable nature of blockchain would assure voters that cast votes could not be tampered with by those who are delegated the task of counting and recording votes.

One major issue with blockchain voting is allowing voters to prove eligibility to vote while remaining anonymous. Two different approaches have been taken in the prior art: linkable ring signatures and blind signatures. Those who take the blind signature approach tend to gloss over the fact that absolute trust is required in the central authority determining eligibility. A blind signature issued by a central authority introduces a potential vulnerability as a corrupt central authority can pass a large number of forged ballots into the mix without any detection.

The main benefits being claimed with blockchain-based voting is to provide a more trustworthy option than current practices, however without addressing the central authority problem those benefits cannot be realized. In order to ensure the legitimacy of elections and the integrity of a democratic process, any system which would be implemented must be able to alert voters of tampering and ideally prevent tampering from occurring. However, the central authority problem allows the election to be tampered with by the central authority in a manner where no auditing could detect the tampering.

Linkable ring signatures allow confirmation that a vote was cast by an eligible voter at the expense of computing a signature over every eligible voter. Those who take the ring signature approach run into resource constraints that grow quadratically with the number of voters. The linkable ring signature eliminates the need of the central authority from doing anything in secret, and all actions of eligibility are in public.

Replacing the blind signature system with linkable ring signatures ensures the integrity of the election by preventing the introduction of forged ballots and allows the record of voters to be completely auditable. While the solution does work, it has very poor efficiency in large scale elections as linkable ring signatures must be constructed and verified against the entire set of voters' keys for each ballot. The weaknesses and inefficiencies in the prior art require an alternative approach to constructing a trustworthy voting system.

### BRIEF DESCRIPTION OF THE DRAWINGS

FIG. 1 illustrates a voting system utilizing a biased blind multi-signature scheme;

FIGS. 2a and 2b illustrate an initialization phase of the voting system;

FIGS. 3a and 3b illustrate a registration phase of the voting system;

FIGS. 4a-4c illustrate a biased signing phase of the voting system;

FIGS. 5a-5c illustrate a voting phase of the voting system; and

FIG. 6 illustrates a counting phase of the voting system.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

The following description focuses on improving the trustworthiness of electronic voting systems by providing possible ways of avoiding or detecting a corrupt central authority (CA) while still utilizing the efficiency provided by the blind signature approach. There are also four formal requirements for elections generally that the system will attempt to achieve: eligibility, privacy, verifiability, and forgiveness. Two other desirable properties of election systems are addressed: fairness and coercion-resistance.

The eligibility requirement holds that only eligible voters should be allowed to cast their vote and should cast only the authorized number of votes. The privacy requirement holds that the way an individual voter voted should not be able to be determined by anyone other than the voter themselves. Verifiability means that all voters have a means to verify that their vote was counted in the final count. This is often defined in two forms: individual verifiability and universal verifiability. Individual verifiability requires that an individual voter can guarantee that his or her vote was counted and counted correctly. Universal verifiability allows anyone to verify that the published election result is the correct result. Forgiveness holds that a voter should have the ability to change their vote after it has been cast so long as the election has not ended.

The fairness property holds that no early results should be obtainable before the end of the election. Fairness is believed necessary by some to prevent undue influence upon later voters who would vote differently if not influenced by the mechanism of how the votes where collected. However, not all elections follow this concept of fairness. Coercion-resistance holds that a coercer should not have the ability to distinguish whether a coerced voter has voted as instructed to. This is a mostly unsolved problem in electronic voting systems when bundled with the other voting requirements. Forgiveness is typically relied upon as a lesser form of coercion-resistance.

Blockchain is a natural choice for data storage in an electronic voting platform because its design enforces individual verifiability. The immutable nature of blockchain assures that a voter's ballot will not be removed from the count and that the election state has not been tampered with. Blockchain can be used to act as a record of state for agreed upon voting procedures allowing for fully auditable elections. However, blockchain can make some elements of electronic voting much worse.

A large concern of electronic voting has focused on how to prevent coercers from knowing if someone has voted as instructed to, and blockchain based voting can make this situation worse. If a coercer is able to compel the private or public keys from a voter, the coercer can explore the blockchain to determine how a user has voted. Secure hardware may be necessary to prevent voters from being able to disclose their keys, but then verifiability is harmed as you are trusting the secure hardware to report your vote to you and cannot confirm it yourself.

Probably the worst-case scenario that can be constructed is the decentralized purchasing of votes. Consider a smart contract that is funded with $100,000,000 in a cryptocurrency and pays out to anyone who proves that they voted for the corrupt candidate by revealing to the smart contract the voter's ballot and proof of control of that ballot. The smart contract could accept a digital commitment during the election and then have a reveal period after the candidate would take office where those that voted for the candidate would have the contract pay out in equal shares to all.

The simplest eligibility system would be one where each voter's ballot is attached with their identity and signed by the CA. Such a design would guarantee an auditable election as auditors could review for ineligible ballots and even remove them from the total vote. Such a naive implementation would fulfill the eligibility and verifiability requirements but prevent privacy requirements from being implemented such that most people would be concerned to use such a system.

Clearly, just the abstract idea of blockchain voting does not necessarily improve a voting system, or even create a satisfactory voting system, and is actually likely to result in a significantly worse overall system. The technical details of the voting system described herein are a specific application of blockchain technology, constituting significantly more than just the abstract idea of applying blockchain to a voting system, resulting in an election system hardened to meet the four formal election system requirements.

A more sophisticated approach to ensuring eligibility must be adopted. A secure voting system requires a means to separate voters' identities from the keys the voters use while still offering guarantees that an individual voter's key comes from the set of valid voters. The linkable ring signature and blind signature approaches described above accomplish this with serious downsides.

A better approach is to use a biased blind multi-signature scheme to gain the assurance of ring signatures with the efficiency of blind signatures. Biased blind multi-signature provides an efficient way to ensure privacy and eligibility constraints while reducing the risk of fraudulent votes entered into the system. Multi-signature schemes scale linearly, and each additional signature required to authorize a ballot is another party that has to conspire to forge a ballot. The problem then becomes how many signatures are enough, and how can you reduce the likelihood that the selected parties will not conspire together to throw the election?

The biased blind multi-signature approach used herein requires that each ballot include a signature from each of the candidates running in the election. If every candidate running must sign each ballot, then every candidate would be required to conspire to help an opponent win, in which case the vote is already a sham. If every candidate were willing to collude in such a manner, then the integrity of the election would be impossible to uphold by any technical means.

The benefits from the biased blind multi-signature approach are clear. The candidates looking out for their best interest are biased to their position and would not be encouraged to collude to let their opponent win. Moreover, only requiring a small set of additional signatures results in a system that scales linearly with the number of voters rather than quadratically as with the linkable ring signature approach, allowing the system to be implemented in large-scale elections. Each new voter only requires that each candidate sign that voter's key.

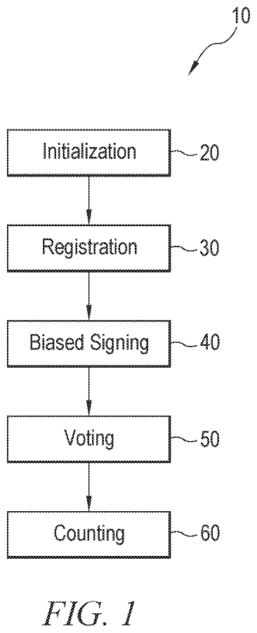

FIG. 1 shows a voting system 10 utilizing the biased blind multi-signature scheme. Voting system 10 is split into five phases as shown in FIG. 1: initialization phase 20, registration phase 30, biased signing phase 40, voting phase 50, and counting phase 60. The phases occur in order as illustrated.

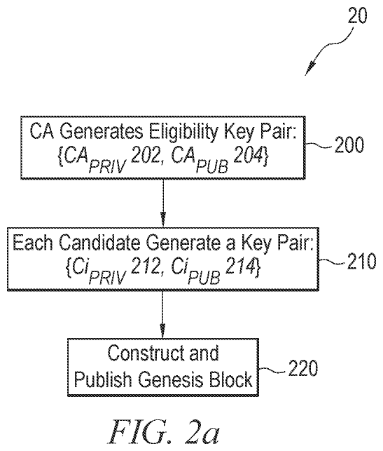

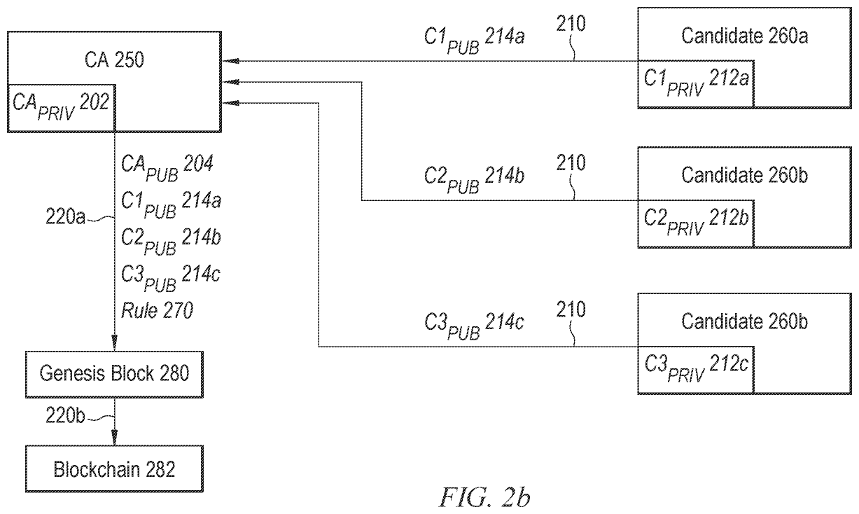

FIG. 2a is a flow chart showing steps that occur in initialization phase 20. During initialization phase 20, the CA starts up the blockchain network and publishes a genesis block with public keys for the CA and all candidates in the election. Any reference to “the blockchain” may refer to one specific blockchain that was previously discussed, any one of multiple blockchains in use, or a new blockchain being created. “The blockchain” commonly refers to multiple blockchains used in conjunction with each other. Any time a single blockchain is described as having multiple uses, those different functions can also be spread out across multiple blockchains. Likewise, anytime multiple blockchains are described those functions can be implemented on a single blockchain. The CA can be a state or federal agency such as a Secretary of State office, a private corporation that contracts out to run elections, or any other entity.

In step 200, the CA generates an eligibility key pair. The eligibility key pair includes a private key CA_{PRIV} 202 and a public key CA_{PUB} 204. Key pairs are generated and used in accordance with well-known principles of public-key cryptography. CA_{PRIV} 202 is maintained as private by the CA so that the public can feel confident that anything signed using the CA's private key has been signed under authorization of the CA. CA_{PUB} 204 will be published to allow anyone to verify whether something was signed using CA_{PRIV} 202. Notably, CA_{PRIV} 202 is used during registration phase 30 to sign each voter's credential after the CA verifies that the respective voter is eligible to vote in the subject election.

In step 210, each candidate also generates a key pair including private key Ci_{PRIV} 212 and public key Ci_{PUB} 214, where C indicates a candidate's key and i is an index to identify a particular candidate. Each candidate for the election being held generates a key pair and provides his or her Ci_{PUB} 214 to the CA for publication. Each Ci_{PRIV} 212 is kept private by the respective candidate.

In step 220, the CA initializes the election by publishing a block to the blockchain. If necessary, a genesis block is created to start up a new blockchain. In some embodiments, a new blockchain with a new genesis block is generated for every election. In other embodiments, a new election is initialized by publishing a new block to an already existing blockchain used for prior elections or other purposes.

The genesis block includes CA_{PUB}204 and each Ci_{PUB} 214 for all of the candidates. Other information and rules for the election are also published as part of the genesis block, such as durations or triggers for each phase. Publishing a block with CA_{PUB}204 and each Ci_{PUB} 214 starts a state machine for the election and triggers the beginning of registration phase 30.

FIG. 2b is a block diagram showing a CA 250 and candidates 260 executing the steps of initialization phase 20 in one exemplary election. The exemplary election includes three candidates 260a, 260b, and 260c. Each candidate generates a private/public key pair, keeping their respective private key Ci_{PRIV} 212 secret but sending their respective public key Ci_{PUB} 214 to CA 250 in step 210. The private keys 212 being within each respective candidate's box in FIG. 2b indicates that the private keys are kept private. The public keys are to be published and will be publicly associated with each public key's respective candidate.

Likewise, CA 250 generates a private/public key pair, keeping CA_{PRIV} 202 private, but publishing CA_{PUB} 204 along with all of the candidate public keys Ci_{PUB} 214. In step 220a, CA 250 creates a genesis block 280 containing the CA public key 204 and all of the candidate public keys 214. The CA 250 will also typically place one or more rules 270 for execution of the election in genesis block 280 with the public keys. Rule 270 can be any technically possible rule, such as controlling the lengths of the phases, how votes are tallied, how many candidates can be voted for, etc. Genesis block 280 is then written to a blockchain 282 to begin registration phase 30. Genesis block 280 may not technically be a genesis block, in that a new blockchain may not be created, if an existing blockchain 282 is being reused for a new election.

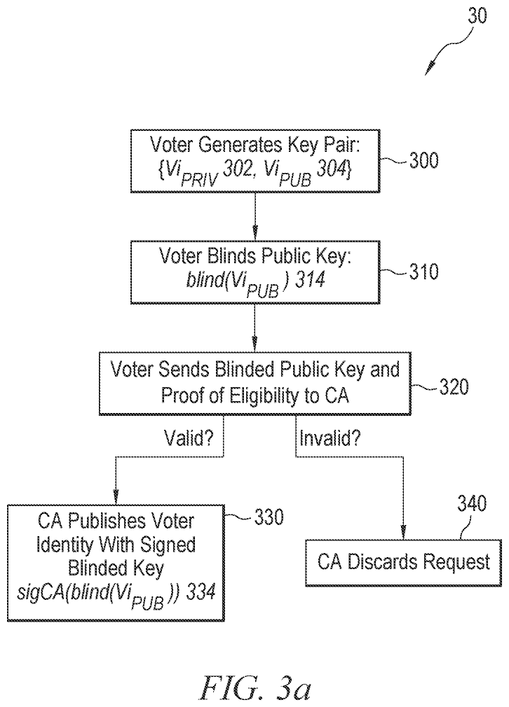

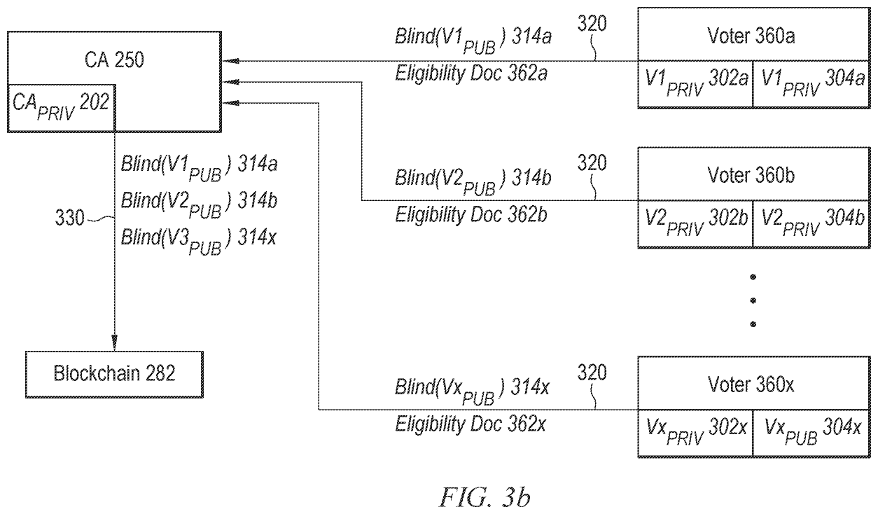

FIG. 3a illustrates the process that occurs for each voter that is registered during registration phase 30. Registration phase 30 can be automatically ended at a predetermined time published as a rule in the genesis block or manually closed when all desired voters have completed registration. The election state machine can end registration phase 30 based on any desired rules published in the genesis block, e.g., rule 270.

The registration process begins in step 300 with each voter generating a key pair comprising Vi_{PRIV} 302 and Vi_{PUB} 304. Vi_{PRIV} 302 is voter i's private key and Vi_{PUB} 304 is voter i's public key.

In step 310, the voter blinds his or her public key to generate a blinded public key referred to as blind(Vi_{PUB}) 314, wherein blind( ) indicates the particular blinding function used and Vi_{PUB} refers to Vi_{PUB} 304 being the input to the blinding function. Blinding can be done by any cryptographic blinding or blind signature technique, of which those skilled in the art will be aware. Blinding is a technique by which Vi_{PUB} 304 can be signed by a 3rd party without revealing the actual public key value to the 3rd party. Blind(Vi_{PUB}) 314 can be signed using, e.g., CA_{PRIV} 202 or Ci_{PRIV} 212, and then the voter can unblind the resulting signature to generate a valid signature for the unblinded Vi_{PUB} 304 that was never revealed.

The formal election requirement for voter privacy holds that the way an individual voter voted should not be able to be determined by anyone other than the voter themselves. This is upheld in the biased blind multi-signature scheme proposed for voting system 10 by utilizing blind signatures to hide which public key belongs to which voter. Because every public key is signed by the CA along with each of the candidates in the election, we know they belong to an eligible voter, but the blinding property of blind signatures holds that the signer cannot learn anything about the message they are signing making it impossible to link any signed key to a specific voter.

The voter sends blind(Vi_{PUB}) 314 to the CA along with proof of eligibility in step 320. Proof of eligibility can be a government issued photo ID, an identification number that refers to the voter within a government database, or any other suitable identifying documents or information. Detailed contents of the eligibility document can be stored off-chain. The off-chain contents are hashed and the hash is stored on-chain. The hash stored on-chain prevents the contents from being mutated without detection during and after an election.

The CA verifies that the voter is eligible to vote in the subject election and that blind(Vi_{PUB}) 314 meets all technical requirements. If the submitted items are valid, then the CA signs blind(Vi_{PUB}) 314 with CA_{PRIV} 202 and publishes the voter's information to the blockchain in step 330. Otherwise, the registration request is discarded in step 340. Signing the blind public key results in a signature sigCA(blind(Vi_{PUB})) 334. SigCA( ) is the function used to create the signature, and blind(Vi_{PUB}) indicates that a voter's blinded public key is the input to the signature function.

The voter's identification is published onto the blockchain along with the voter's CA-signed blind(Vi_{PUB}) 314. Publishing the voter's identification and blinded public key allows the auditing of all eligible voters. The voter will use Vi_{PUB} 304 to vote, which cannot be associated with the corresponding blind(Vi_{PUB}) 314 and therefore maintains anonymity. The voter's identity published in step 330 cannot be readily linked to the voter's cast vote later. Initialization and registration are fully public and auditable thanks to the immutable nature of the blockchain.

The process for registration phase 30 shown in FIG. 3a is repeated for each voter desiring to register to vote during the registration phase. FIG. 3b continues the example of FIG. 2b, showing CA 250 handling registration for voters 360a-360x. Voter 360x represents the last voter in a set of voters of indeterminant number. Each voter 360 generates a private key 302 and a public key 304. Unlike the candidates 260, voters 360 keep both public key 304 and private key 302 private, as indicated by both keys remaining within the voter's respective square in FIG. 3b.

Instead of voters publishing their public keys as with the candidates, voters blind their keys using the blinding function blind( ) to generate a blinded key 314. Each voter 360 sends their blinded key 314 and the required eligibility document 362 to CA 250 in step 320. CA 250 confirms the eligibility of each voter 360 using eligibility documents 362 and then signs and publishes the blinded keys 314 to blockchain 282.

Eventually, registration phase 30 ends and biased signing phase 40 begins. The end of registration phase 30 may occur automatically by virtue of a rule of the blockchain's state machine as published in the genesis block. In other embodiments, the CA publishes an end block to the blockchain that marks the end of registration phase 30. Using the timeserver properties of a blockchain guarantees that different events occur in proper sequence. This property can be utilized by operation of the state machine, by the construction of segmented blockchains, or by having separate blockchains with separate genesis blocks for registration and voting.

In some embodiments, the blockchain where the CA publishes authorized voter identifications and blinded public keys is reused across multiple elections. Individual voters do not need to redo the steps from registration phase 30 for subsequent elections once their authorization is published on the blockchain for a first election. Only new voters will need to register during registration phase 30.

One aspect of reusing the authorization blockchain between elections is that, while the voter's public keys Vi_{PUB} 304 remain anonymous and unconnected to specific voter identities, it would be public knowledge how a specific public key voted across multiple elections. This might be considered desirable information by political analysts without any serious downside to election integrity. However, completely redoing registration phase 30 each election will reduce the amount of information about how people voted that can be gleaned from analysis of the blockchain and may be desirable.

To deauthorize a voter, the CA can publish a block to the blockchain indicating that a specific voter is no longer eligible to vote, e.g., if the voter moved out of the jurisdiction. Voters can be removed during registration phase 30 or between elections, but there is no way to remove someone once voting phase 50 begins. In some embodiments, the last opportunity to remove a voter has passed once each candidate signs that voter's blinded private key and publishes the signatures to the blockchain.

Voting is completely anonymous, so once voting phase 50 starts with someone as an authorized voter there is no way to know which vote was cast by the ineligible voter to enforce a deauthorization. In order to remove someone during the voting phase, the election system would have to be intentionally designed with a way to breach privacy. Even without a technical way to prevent voting after the voting phase starts, there is still the option to prosecute someone under the law if there is evidence of illegal activity, as is already the case with traditional voting.

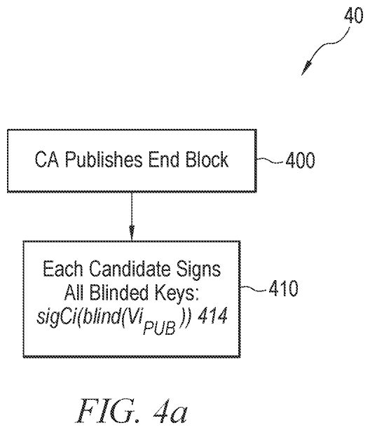

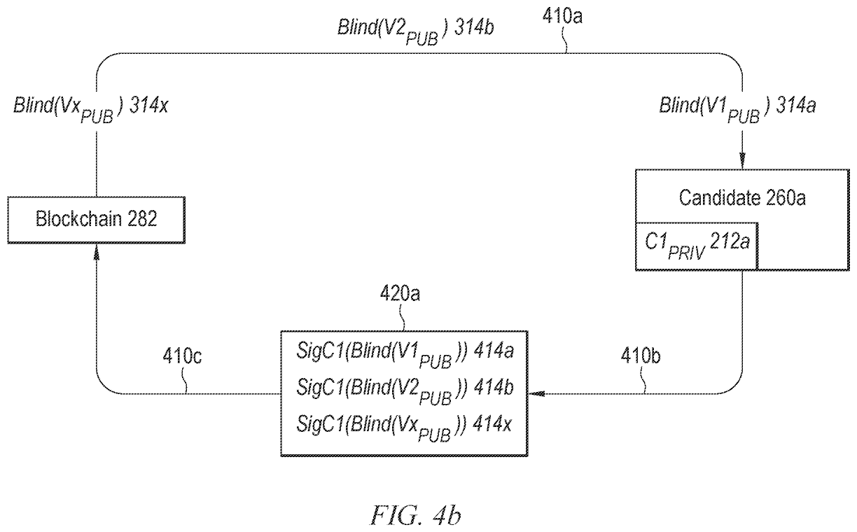

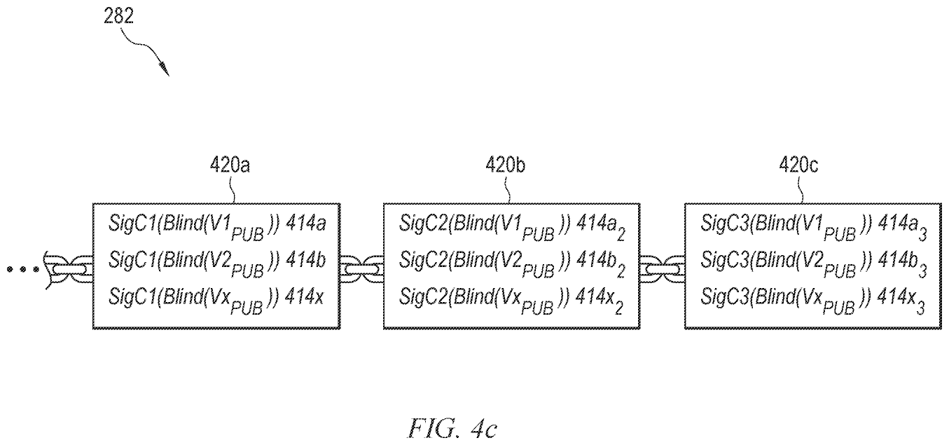

FIG. 4a shows biased signing phase 40 beginning with CA publishing an end block in step 400 for ease of illustration. Biased signing phase 40 may be entered automatically by operation of the election's state machine without an end block being published.

In step 410, each of the candidates uses their Ci_{PRIV} 212 to sign each voter's blind(Vi_{PUB}) 314 that the CA published to the blockchain to create a signature sigCi(blind(Vi_{PUB})) 414. Each candidate signs each voter's blinded public key and publishes the signature to the blockchain.

Requiring that each candidate sign each voter's public key in addition to the CA ensures that a corrupt CA is unable to add fake voters into the election by injecting fake voter keys into the auth blockchain. Only voters that are authorized by the CA and also confirmed by all candidates are able to vote during voting phase 50. While the number of signatures required is greatly reduced compared to the prior art linkable ring signature approach, security is maintained by ensuring that the parties required to sign have a bias against each other and are unlikely to collude to throw the election.

Having each candidate sign off on the identities submitted to that blockchain as opposed to having the CA alone sign the blinded keys prevent a CA attack while increasing the total number of signatures per voter linearly instead of quadratically. In order to ensure the election can continue, each candidate must sign each voter's blinded public signature such that every valid voter can prove eligibility by signing their ballot with a private key which has a public key signed by each candidate. Biased signing phase 40 only ends when every identity with a blinded signature in the blockchain has been signed by every candidate key from the genesis block. Biased signing phase 40 can end automatically by operation of the blockchain once this condition is met.

Variations on how to end biased signing phase 40 can exist, such as using a pre-determined time limit where any biased signers who failed to complete are removed from the ballot or lose the chance to sign ballots giving up their protections. Alternatively, the CA could have an option to arbitrarily end the phase with the same consequences to any biased signer that had not completed it.

In one embodiment, the blockchain network requires that candidates submit a single block with every blinded key signature at once. A block would only be accepted by the network in biased signing phase 40 if every blinded key on the blockchain has a matching valid signature in the submitted block. If any are missing, the network rejects the block. Requiring all the signatures from a candidate at once has several benefits. If the network only accepts that a candidate has completed their requirement when the blinded keys of all eligible voters are submitted, compliance with the biased signing requirement is ensured and candidates are prevented from leaving any voters out. Secondly, it prevents any voter from having access to a signed public key before all the other keys are signed, reducing the likelihood of a timing attack or leak.

Registration phase 30 and biased signing phase 40 ensure the eligibility election requirement is met by having a CA, which would be a governing agency tasked with determining eligibility, have eligible voters register with them so that their identities and generated blinded public keys can be published. Once published in a blockchain of eligible voters, each candidate along with the CA, sign the published blinded keys and publish their signatures.

Biased signing phase 40 is generally going to have to be redone every election with the new set of candidates. Technically, any candidates that existed in prior elections may not need to re-sign any specific voter credentials that also existed in the same prior elections if the blockchain state machine allowed such a scheme.

FIG. 4b continues the example of FIGS. 2b and 3b and shows a candidate 260a reading each voter's blinded key 314 from blockchain 282 in step 410a. Candidate 260a uses their private key 212a to sign each of the blinded signatures 314 and generates a block 420a with each resulting signature 414 in step 410b. Block 420a is published to blockchain 282 in step 410c. The process of biased signing phase 40, illustrated in FIG. 4b from the candidate's perspective, is repeated by each candidate. Biased signing phase 40 ends when blockchain 282 includes a block 420 for each election candidate, as illustrated in FIG. 4c. Blockchain 282 in FIG. 4c shows three blocks 420a, 420b, and 420c that include signatures for each voter 360 by all three candidates 260. There is nothing else that needs to occur in biased signing phase 30, so voting phase 50 can commence.

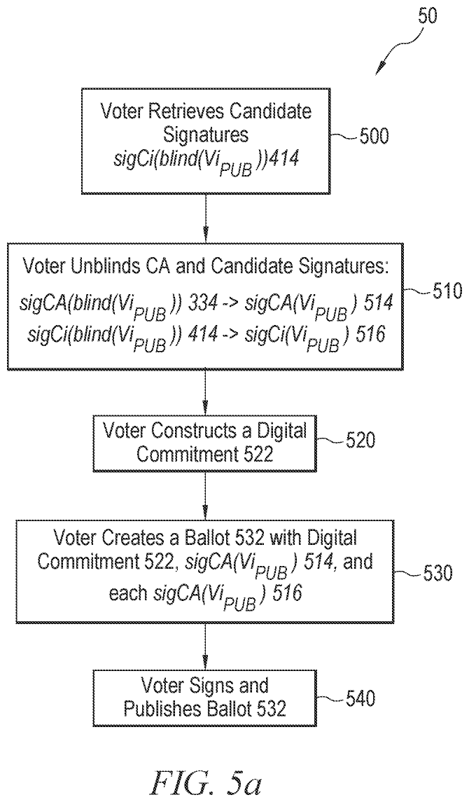

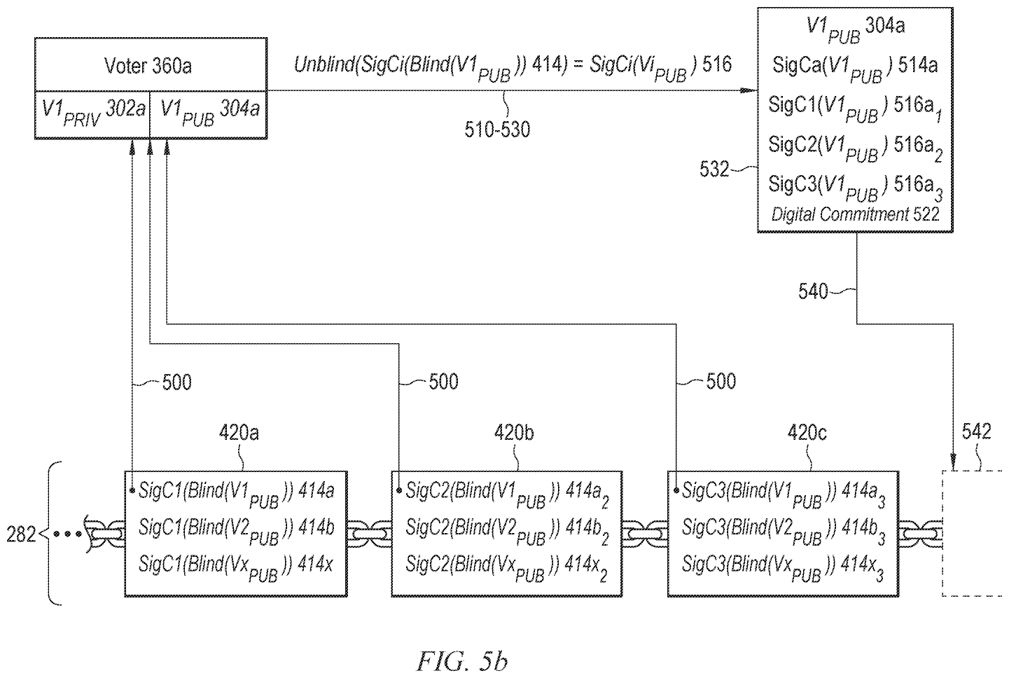

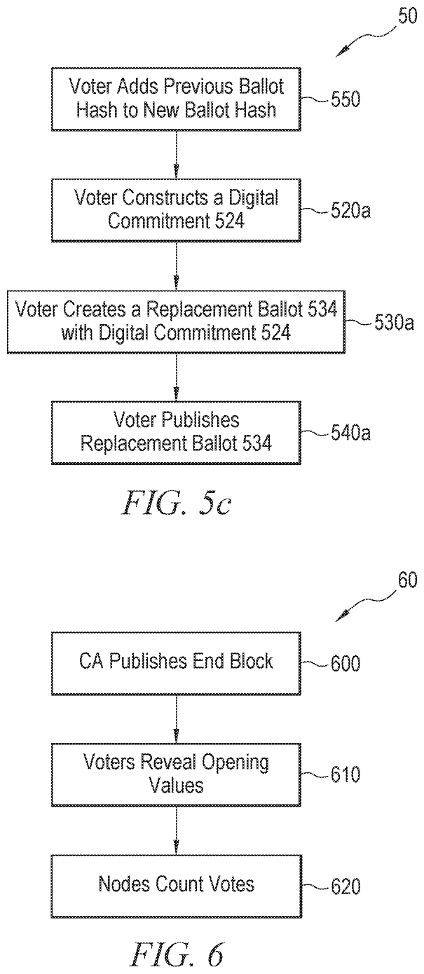

Voting phase 50 is shown in FIGS. 5a-5c. FIG. 5a shows a process that a voter executes to cast a vote. Voting phase 50 will generally start automatically by operation of the blockchain state machine once all candidates have signed all voters' blinded keys. The beginning of voting phase 50 may also be scheduled for a specific date and time or started manually by the CA publishing an end block. With biased signing phase 40 closed, no more valid ballots can be created because the blockchain nodes will not accept any more signed blinded keys. The blockchain creates an auditable trail of exactly who is eligible to vote in the subject election.

To vote during voting phase 50, the voter will first retrieve the CA signature sigCA(blind(Vi_{PUB})) 334 and all of the candidates' signatures sigCi(blind(Vi_{PUB})) 414 for their specific blinded key from the blockchain in step 500. The blinded key signatures will be associated with the voter on the blockchain for retrieval. The voter can use their blinded key to look up all of the signatures that were generated on their blinded key.

Voting system 10 ensures eligibility requirements are met by requiring the biased signers' signatures to publish a valid ballot. This is a cryptographic proof that the voter was eligible to vote. In addition, it requires that the eligible voters be published in a blockchain, which acts as an immutable, auditable record of the ballots issued. Private or sensitive data can be hashed off-chain to protect privacy.

In step 510, the voter will unblind the CA signature and all of the candidate signatures. The unblinding process converts signatures sigCA(blind(Vi_{PUB})) 334 and sigCi(blind(Vi_{PUB})) 414 that the CA and candidates generated into signatures sigCA(Vi_{PUB}) 514 and sigCi(Vi_{PUB}) 516 that are signatures valid for the voter's unblinded public key. The blinding, which was added to the voter's public key before signing, is removed from the signatures using an unblinding function to result in signatures that can be verified against the CA and candidates' public keys to show that the voter's unblinded key was signed. The unblinded public key is a public key signed by the CA and all candidates to prove eligibility for the subject election. When voters unblind the signatures they now have the means to prove membership to the set of eligible voters such that others can validate any accepted ballot in the blockchain and be reasonably assured it came from an eligible voter.

The unblinded signatures sigCA(Vi_{PUB}) 514 and sigCi(Vi_{PUB}) 516 are published to the blockchain and will allow the blockchain state machine, and also the public in general, to verify that a vote cast with the voter's key pair Vi_{PRIV} 302 and Vi_{PUB} 304 was cast by an eligible and authorized voter. The unblinded signatures can be published to the blockchain at any point in voting phase 50, e.g., immediately at the start of the voting phase or at the same time as a vote is published. In some embodiments, unblinded signatures 514 and 516 must be uploaded prior to or at the same time as a vote being cast because the blockchain state machine relies on the existence of the unblinded signatures to determine whether a vote is valid before publishing it.

In step 520, the voter constructs a digital commitment 522. Digital commitment 522 holds a vote selection for the subject election but is encrypted so that the public cannot determine who the vote is cast for from the digital commitment without the key. In one embodiment, digital commitment 522 is generated by hashing the voter's choice along with a randomly generated string. The voter's choice is revealed after voting phase 50 is complete by the voter publishing their choice and the randomly generated string used to create digital commitment 522.

When using the hash based digital commitment a voter would commit to a choice by hashing their choice and a random string. To reveal their choice, the voter would have to publish their choice along with the secret string. For example, let's say a voter wants to vote for candidate “John Smith” and generates a secret string “TWJL+JTVX×1ORSZ+b6PqCrbI”. For the submitted ballot, the digital commitment is a hash of the concatenated string “JohnSmithTWJL+JTVX×1ORSZ+b6PqCrbI”. So on the voter's ballot, all the public sees is a hash of that concatenated string. Now, during the counting phase, the voter would reveal their choice and the random string as their opening secret. The blockchain nodes, CA, or public in general would then hash the concatenated string posted as the opening secret and verify that the hash posted in the ballot matched. If the hashes did not match then the choice being revealed during counting was not the one committed to at the time of the vote.

Alternatively, all digital commitments 522 for all voters could use the same secret across an entire election to simplify voting logistics. The secret could be a public/private key pair controlled by the election officials or split via Shamir secret sharing amongst the candidates. After the voting phase ends, the private key is released so everyone can decrypt the choices of all voters.

Using a digital commitment to hide who each vote is cast for is optional. If the election administrators desire incomplete results be known while voting is still ongoing, then the voter's selections can remain in plaintext when cast.

In step 530, the voter creates a ballot 532 with digital commitment 522 and all of the public key signatures 514 and 516. If the public key signatures were previously published to the blockchain, then ballot 532 may not need to also have the signatures.

In step 540, ballot 532 is signed using the voter's private key Vi_{PRIV} 302 and published to the blockchain along with the voter's public key Vi_{PUB} 304. Vi_{PUB} 304 was never publicly tied to a particular voter, so publishing ballot 532 in step 540 does not tie a vote to a particular voter. With digital commitment 522, Vi_{PUB} 304, sigCA(ViPUB) 514, and sigCi(ViPUB) 516 all published on the blockchain, ballot 532 can be confirmed as being a valid vote cast by an eligible voter without revealing who the vote was cast by or for.

Each authorized blockchain node receives all valid ballots from the network and confirms compliance with the requirement for matching signatures from the CA and all candidates. If all required signatures match, then the ballot is added to the next block. A voter will be able to see when their ballot was accepted by an authorized node and could file a report if their valid vote was not added without having to reveal how they voted. Anyone can audit the blockchain and verify that all ballots have a valid authorized signature and a valid consistent hash.

FIG. 5b shows a voter 360a going through the voting process. Voter 360a retrieves each of their respective blinded signatures 414 in step 500, one for each candidate in the election. In steps 510-530, voter 360a uses an unblinding function, which is the inverse of blinding function originally used to create blind(Vi_{PUB}) 314, to create a signature 516 valid against their public key 304 for each candidate. Ballot 532 is constructed with the voter's public key 304, the CA's signature 514 if required, each candidate's signature 516, and the digital commitment 522 with the voter's choice encrypted. In step 540, ballot 532 is written to a new block 542 of blockchain 282 to cast the ballot. Ballot 532 is published to a different blockchain specifically for cast votes in other embodiments.

Logistically, voting phase 50 may occur in a few different ways. A voter may take a hardware module issued during registration phase 30 to a voting center run by the CA to vote. There may be precinct or district-based voting centers as exist traditionally, with voting machines equipped to interface with the voter's hardware module, e.g., by inserting the hardware security module into a slot or socket on the voting machine. The voting machine would communicate with the hardware security module using electrical contacts. The communication could occur over a proprietary electrical and data interface or a common consumer interface, e.g., Universal Serial Bus (USB). Voting could also occur completely on the voter's phone or computer over the internet using an app or program.

Even with voting from anywhere over the internet, some sort of hardware security module that the voter is issued would typically be used rather than directly storing the voter's private keys on their phone or computer storage. The hardware security module reduces the likelihood of a virus on someone's computer being able to access and steal private keys. The hardware security module will be designed to never reveal private keys. The hardware module just signs whatever it is sent when the user clicks a physical sign key or otherwise interacts to indicate a signature should be generated. The hardware security module could generate a ballot after receiving confirmation of the request from user separately from the computer they are using. Likewise, a phone application can fill the same role. Another computer or a phone can be used to redundantly view the voter's data to confirm that the ballot they submitted was received as they intended and was not hijacked by malicious software.

The complexity of the steps a voter must complete in voting system 10 can be easily concealed behind simple user interfaces, minimizing the steps any party must complete. The hardware or software systems can collect the biased signatures, perform the unblinding, and construct the digital commitments behind-the-scenes. After the election ends, anyone would be capable of counting the ballots on the blockchain. Any process described herein as being done by the voter may be performed either by the voter explicitly or on the voter's behalf by the hardware security module, by a computer application in concert with the hardware security module, or by a computer application alone.

The hardware security module can be reused for multiple elections. No change is needed to the hardware module since the same private key can be reused every election to retrieve the new candidate-signed blinded keys to vote.

The formal election requirement of forgiveness holds that a voter should have the ability to change their vote after it has been cast so long as the election has not ended. This is a lesser form of coercion-resistance and is upheld through the use of alternative ballots. When a voter wants to change their ballot, they need only reference their prior ballot, construct a new digital commitment, and cast the new digital commitment signed with their key pair.

FIG. 5c shows the process for a voter changing their vote. Allowing subsequently changing a previously cast ballot is not a required feature of voting system 10 and may be left out of some embodiments. In step 550, a voter adds the hash of their previous ballot 532 to a new ballot hash. Steps 520-540 are repeated with the new hash as steps 520a-540a to create a replacement ballot. In step 520a, a replacement digital commitment 524 is constructed. The same secret can be used to encrypt digital commitment 524 as was used for digital commitment 522, or a new secret can be generated. In step 530a, the voter signs the replacement digital commitment 524. In step 540a, the voter publishes replacement ballot 534 with the replacement digital commitment 524 and the updated hash linking back to the previous ballot 532.

A voter can continually publish replacement ballots to change his or her vote. The process of revoting can optionally be rate limited to prevent denial of service attacks. A reasonable limit might be a certain number of votes per day, a cool-off period after each vote, a cool-off period that grows with successive votes, or a global maximum number of votes per election. In any case, publishing a vote rescinds all previous votes and only the most recent vote will ultimately count.

The end of voting phase 50 will start counting phase 60, illustrated in FIG. 6. Counting phase 60 can begin automatically by operation of the blockchain state machine being programmed to automatically end voting at a particular date and time. Alternatively, the CA manually publishes an end block in step 600 at the desired end of voting phase 50.

At the beginning of counting phase 60, voters reveal the opening value of their digital commitments 522 in step 610. The opening values can be the random string each voter generates on their own that is used to encrypt their election choice. The opening value each voter publishes can be any piece of information or data in any suitable digital commitment scheme. Only the opening value for each voter's last vote would typically be published.

Voters revealing their opening values in step 610 may occur automatically by the mobile phone app or hardware module that voters use to cast their votes. Even without the voter actually having to take an affirmative step to reveal their opening value, there is still the requirement that some additional step occurs by the voter or on the voter's behalf after voting has completed.

The alternative schemes whereby candidates or the CA keep a universal opening value for all votes eliminates the risk from some voters being technically unable to reveal their opening values. The tradeoff is that if the CA holds the universal opening value, then the CA can observe results at any time during voting phase 50. Such early results may be used for bad faith reasons, e.g., to help a preferred candidate of a corrupt election official. However, a policy decision may be made that the convenience is worth the risk.

Having the universal opening value held by all of the candidates in a Shamir secret requiring multiple or all candidates to cooperate to reveal the opening value improves the process in much the same way as biased signer phase 40. Candidates, who are biased against each other, would have to cooperate in order to reveal results early just like they would have to cooperate together to create fraudulently valid voting credentials.

Whether the opening values are revealed by voters, by the CA, or by the candidates in step 610, all blockchain nodes count the votes in step 620. Opening values are used to reveal each cast vote and the votes are summed to determine a number of votes for each person or option. Each node of the blockchain network begins opening the ballots. To verify that a voter is eligible, the nodes verify that all required signatures are valid and that only one ballot is counted per voter. Each node counts up the entire vote and reports the outcome of the election. Because the entire process occurs on a public blockchain, every stakeholder, from voters to candidates to government agencies and the news media, is able to verify that the vote count was accurate and only eligible voters participated.

The biased blind multi-signature scheme of voting system 10 ensures that the CA does not fraudulently create fake voters like the blinded signature scheme without increasing the number of signatures for each voter quadratically like the ring signature scheme. With the new approach to handling voter verification and the introduction of blockchain ledgers, an approach is created such that when a ballot is confirmed to the chain the voter and auditors can be assured the vote was cast, counted, and made from the ballot holder. Voters can ensure that their personal vote was cast and counted as intended.

The formal requirement of verifiability has two parts, both of which are met in voting system 10. The first, individual verifiability, holds that an individual voter can guarantee that his or her vote was counted and counted correctly. By having votes collected in a publicly viewable blockchain, any voter can view that their vote was accepted by the network as well as verify that their vote as stored correctly reflects how they voted.

The second part, universal verifiability, holds that anyone should be able to verify that the published election results are the correct results. Universal verifiability is upheld by the use of blockchain's immutable design preventing any ballots from being removed from the election and the digital signatures ensuring each of the ballots have come from a valid voter and not been tampered with. With a publicly viewable blockchain anyone could verify the results of the vote with a reasonable assurance of accuracy.

The scheme of voting system 10 protects the integrity of the election by placing the eligible voters in a publicly viewable blockchain and then constructing blinded keys from that publicly viewable blockchain which all candidates must sign. Since every candidate has signed each eligible voter's eligibility key, any vote cast will be assured to have been from a voter all candidates have validated. Voting system 10 ensures that there are auditable results by using blockchain to validate compliance and create an immutable record. The record of eligible voters is distributed and auditable by the blockchain's design. The votes are also auditable as they are submitted on a publicly viewable blockchain and signed off with a unique eligibility token that is signed by all candidates in the election.

The biased signer voting phase along with a publicly viewable blockchain will help ensure voters that the election is secure, and the results accurate. If a voter sees that their candidate of choice had to sign off on every ballot that is counted, they will most likely be more willing to accept the results of the election. The public nature of the biased signer phase can help each voter achieve psychological acceptance of voting system 10.

Voting system 10 is described above generically such that the voting system could be built in a custom blockchain framework or a smart contract language like Solidity or Cosmos. In a language like Solidity, the state would be held in a smart contract and not established in the genesis block. In some embodiments, voting system 10 uses a blockchain, distributed ledger, or other distributed immutable data storage that has either a non-forking consensus algorithm or a mechanism to add votes from a forked chain into the new main chain.

Disallowing forks is preferred so that once a voter submits their choice and the system accepts it, there will be no way for the vote not to be counted. The problem with forks could present itself if a voter submitted a ballot and the blockchain were forked prior to the vote being committed to the blockchain. An example of a preferred consensus algorithm that is not forkable would be an Istanbul Byzantine Fault Tolerant consensus algorithm running on a private blockchain.

Ethereum has a proof of work consensus algorithm which means that there can be forks. Therefore, Ethereum may not be an ideal medium for voting system 10. An Ethereum blockchain could be forked without someone's vote and that person may not be aware of it. Byzantine Fault Tolerance cannot be forked. All voters get a receipt, and if their vote is not in the blockchain during counting phase 60 they can prove something is wrong with the chain.

In addition, blockchains that require having to pay gas, as with Ethereum, may be problematic due to breaking anonymity. Gas introduces a privacy concern as, even with blinding signatures and ring signature schemes, a user must spend the gas to interact with the contract, thus creating a traceable link to the real identity of the user because the blockchain would publicly show who paid the gas for each vote. With a custom solution, gas requirements can be eliminated.

When creating a custom solution, be it on Quorum, Ethereum, Hyperledger, Cosmos, or building a custom platform, there are two major components that need to be accounted for: the proof of authority keys which allow the authorized CA to add identities at the beginning as well as to administrate the end blocks, and then finally a proof of compliance model which allows voters to vote by proving compliance with the election (well-formed ballot, properly signed eligibility token) in a manner which does not leak any new information related to the voter as the public Ethereum chain would. The proof of compliance model would be implemented by a smart contract in either Ethereum or Hyperledger but could be built into the consensus model if you wrote your own implementation for efficiency.

If a smart contract is used, one goal might be to offload as much of the computation from the network as possible. When signatures are generated, blinded, unblinded, or when digital commitments are created and opened, etc., all the computation is done client-side off the blockchain such that the blockchain only needs to verify compliance. In this way, the blockchain is merely an immutable record of state that the voting program will use to reach consensus on an election's outcome. Elliptic Curve Digital Signature Algorithm (ECDSA) is the default signing method on most blockchain networks, and several efficient ECDSA blind signature algorithms have been proposed. Alternatively, Ethereum offers built-in smart contracts for verifying RSA signatures which could be used.

For advanced embodiments, the CA may need to administer a variety of elections concurrently with various overlapping levels of jurisdictions, e.g., state-wide, county, city, and congressional elections that typically occur at the same time on one physical ballot. Multi-jurisdictional elections can be implemented relatively simply by using a keyring design with a master key controlling the subkeys. A keyring can be implemented in the voting system to separate keys for different jurisdictions as well as for separating keys per election.

Instead of having the user submit a blinded public key during the registration phase, the voter submits a standard public key to act as the master signing key of the users' keyring. The master signing key would be added to the blockchain by the CA. The user can construct new key pairs for each of the different jurisdictions or the new election and blind those key pairs. The voter then submits the blinded key pairs to the blockchain and sign the transaction, assigning those blinded keys to themselves using the private key associated with the public key that has already been submitted by the CA.

Each blinded key would go into a unique keeper for the associated jurisdiction. During biased signing phase 40, the candidates for that jurisdiction, and that jurisdiction only, sign the blinded key stored in that jurisdiction's keeper. Each candidate would sign the blinded keys for only their jurisdiction. During voting phase 50, the voter can submit their ballot, and it would be broken up by jurisdiction, where each jurisdiction has a separate ballot recorded digitally. The eligibility token is the public/private key pair for that jurisdiction. Because only candidates running in the jurisdiction sign each eligibility token, voters cannot sign a ballot in a separate jurisdiction with one of their other eligibility tokens. This allows users to vote without having their choices in different jurisdictions being able to be linked together.

Voting system 10 was designed to make state-sized elections secure and trustworthy. However, voting system 10 can also be used in other smaller elections such as a corporate board meeting or any time a poll needs to be conducted between a known set of individuals anonymously. While a voter is specifically discussed above as the end user, voting system 10 could be used in other cases besides voting, in which case the individual would be considered a user not a voter. Anything discussed above for a voter could also be true for a user of the system.

Outside of voting, voting system 10 could be used to create anonymous designs such as webchats, forums, mobile or PC applications, or other communication or interactive platforms for which only an authorized set of people should be able to access. Voting system 10 can be used as a scheme to sign things outside of voting, using the details of the voting system as a decentralized scheme for key authentication. In the keyring design, users would have a public identity key and an anonymous identity key that sites could use to verify the user in either context. Using the scheme of voting system 10 would allow a site to allow anonymous users while still being able to ban users. Keys tied to identity in the keyring embodiment could be used to sign documents much more securely than currently possible.

While one or more embodiments of the present invention have been illustrated in detail, the skilled artisan will appreciate that modifications and adaptations to the embodiments may be made without departing from the scope of the present invention as set forth in the following claims.

What is claimed:

1. A method of voting, comprising:
generating a voter key pair including a voter private key and a voter public key;
blinding the voter public key to generate a blinded voter public key;
generating a plurality of candidate key pairs, wherein each candidate key pair includes a candidate private key and a candidate public key;
signing the blinded voter public key with each of the plurality of candidate private keys or a subset of the plurality of candidate private keys to create a plurality of blinded signatures;
unblinding the plurality of blinded signatures to generate a plurality of unblinded signatures valid for the voter public key; and
casting a vote using the voter public key and the plurality of unblinded signatures.

2. The method of claim 1, further including publishing the blinded voter public key to a blockchain by submitting the blinded voter public key to an election authority along with proof of eligibility to vote in the election.

3. The method of claim 2, further including publishing the plurality of blinded signatures to the blockchain.

4. The method of claim 1, wherein casting the vote includes:
constructing a first ballot comprising a choice of candidate and the plurality of unblinded signatures; and
publishing the first ballot to a blockchain.

5. The method of claim 4, wherein casting the vote further includes committing to the choice of candidate using a digital commitment prior to constructing the first ballot.

6. The method of claim 5, further including publishing an opening value for the digital commitment onto the blockchain after a voting phase is complete.

7. The method of claim 4, further including publishing a second ballot to the blockchain, wherein the second ballot supersedes the first ballot.

8. The method of claim 1, further including initializing the election by publishing a block to a blockchain, wherein the block includes each of the candidate public keys or a subset of the candidate public keys.

9. A method of managing cryptography keys, comprising:
providing a user key;
blinding the user key to create a blinded user key;
signing the blinded user key with a plurality of biased party keys to create a plurality of blinded signatures; and
unblinding the plurality of blinded signatures to generate a plurality of unblinded signatures valid for the user key.

10. The method of claim 9, further including casting a vote using the user key and the plurality of unblinded signatures.

11. The method of claim 10, further including verifying the vote by confirming that one or more unblinded signatures of the plurality of unblinded signatures is valid for the user key.

12. The method of claim 10, further including casting the vote by constructing a digital commitment containing a selection.

13. The method of claim 10, further including casting the vote by publishing a ballot to a blockchain.

14. The method of claim 9, wherein a user publishes the blinded user key to a blockchain by submitting the blinded user key to an authority with proof of eligibility.

15. The method of claim 9, wherein the plurality of blinded signatures is created and published by a plurality of biased parties.

16. The method of claim 15, wherein a user retrieves the plurality of blinded signatures from the blockchain prior to unblinding the plurality of blinded signatures.

17. The method of claim 9, further including generating the user key using a master signing key.

18. The method of claim 17, further including generating a second user key using the master signing key.

19. The method of claim 17, further including using the master signing key to log into a webpage or application.

20. The method of claim 17, further including using the master signing key to sign a document.

21. The method of claim 9, further including using the user key to log into a webpage or application.

22. The method of claim 9, further including using the user key to sign a document.

23. A method of administering a voting system, comprising:
accepting a plurality of candidate keys from a plurality of candidates;
publishing a block to a blockchain, wherein the block includes the plurality of candidate keys;
accepting a voter key from a voter;
publishing the voter key to the blockchain;
starting a voting phase after the voter key is signed by each of the plurality of candidates or a subset of the plurality of candidates; and
ending the voting phase after the voter publishes a ballot to the blockchain.

24. The method of claim 23, wherein ending the voting phase occurs automatically.

25. The method of claim 23, wherein starting the voting phase occurs automatically.

26. The method of claim 23, further including:
accepting a plurality of voter keys; and
waiting until a threshold subset of the plurality of candidates signs a threshold subset of the plurality of voter keys before starting the voting phase.

27. The method of claim 23, further including confirming eligibility of the voter to vote prior to publishing the voter key to the blockchain.

28. The method of claim 23, further including providing a hardware security module containing the voter key, wherein voter uses the hardware security module to sign a transaction.

29. The method of claim 23, further including:
storing a personal information of the voter off of the blockchain; and
storing a hash of the personal information on the blockchain.
